(19) United States
(12) Patent Application Publication
(10) Pub. No.: US 2025/0190705 A1
(43) Pub. Date: Jun. 12, 2025

(54) INFORMATION PROCESSING DEVICE, INFORMATION PROCESSING METHOD, AND RECORDING MEDIUM

(71) Applicant: NEC Corporation, Tokyo (JP)

(72) Inventors: Yoshio KAMEDA, Tokyo (JP); Shinnosuke Nishimoto, Tokyo (JP); Keita Sakuma, Toky (JP); Ryuta Matsuno, Tokyo (JP); Masakazu Hirokawa, Tokyo (JP)

(73) Assignee: NEC Corporaton, Tokyo (JP)

(21) Appl. No.: 18/942,827

(22) Filed: Nov. 11, 2024

(30) Foreign Application Priority Data
Dec. 12, 2023 (JP) 2023/209025

(51) Int. Cl. G06F 40/30

(52) U.S. Cl. CPC G06F 40/30

(57) ABSTRACT

In an information processing device, a prompt acquisition means acquires a prompt which is described in natural language and includes a designation of a task. An input variable acquisition means interprets the prompt using a language model, acquires related information corresponding to the task designated by the prompt, and acquires an input variable to be used for prediction corresponding to the task designated, based on the related information. An output means outputs the input variable acquired.

### TECHNICAL FIELD

This disclosure relates to prediction using a machine learning model.

### BACKGROUND ART

Various predictions have been made using a machine learning model. In general, a model designer such as a data scientist selects appropriate explanatory variables based on knowledge concerning a domain to which the machine learning model is applied, and creates the machine learning model for use in prediction. However, it requires sufficient knowledge and experience to select appropriate explanatory variables in the design of the model. Patent Document 1 discloses an explanatory variable proposal device that extracts each explanatory variable effective for an objective variable input by a user and presents each explanatory variable to the user.
Patent Document 1: Japanese Patent Application Laid-Open under No. JP 2023-141204

### SUMMARY

One object of the present invention is to enable generation of each appropriate explanatory variable or feature concerning a task of an interest even if a person does not necessarily have sufficient knowledge and experience related to a development and operation of a machine learning model.

According to an example aspect of the present invention, there is provided an information processing device comprising:
at least one memory configured to store instructions; and
at least one processor configured to execute the instructions to:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

According to another example aspect of the present invention, there is provided an information processing method performed by a computer and comprising:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

According to still another example aspect of the present invention, there is provided a non-transitory computer-readable recording medium storing a program, the program causing a computer to execute processing of:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

### Effect

According to the present disclosure, it is possible to enable generation of each appropriate explanatory variable or feature concerning a task of an interest even if a person does not necessarily have sufficient knowledge and experience related to a development and operation of a machine learning model.

### BRIEF DESCRIPTION OF THE DRAWINGS

FIG. 1 illustrates an overall configuration of a design support system to which an information processing device according to the present disclosure is applied.

FIG. 2 is a block diagram illustrating a hardware configuration of a server device.

FIG. 3 is a block diagram illustrating a hardware configuration of a terminal device.

FIG. 4 is a block diagram illustrating a functional configuration of the terminal device and the server device.

FIG. 5 illustrates an example of predictive formula data stored in a predictive formula database.

FIG. 6 illustrates an example of explanatory variable data stored in an explanatory variable database.

FIG. 7 illustrates an example of processing method data stored in a processing method database.

FIG. 8 illustrates another example of the predictive formula data stored in the predictive formula database.

FIG. 9 illustrates another example of the processing method data stored in the processing method database.

FIG. 10 illustrates an example of a prompt which a user inputs.

FIG. 11 is a flowchart of an input variable proposal process.

FIG. 12 is a block diagram illustrating a functional configuration of an information processing device of a second example embodiment.

FIG. 13 is a flowchart of a process performed by the information processing device of the second example embodiment.

### EXAMPLE EMBODIMENTS

Preferred example embodiments of the present disclosure will be described with reference to the accompanying drawings.

### First Example Embodiment

### [Overall Configuration]

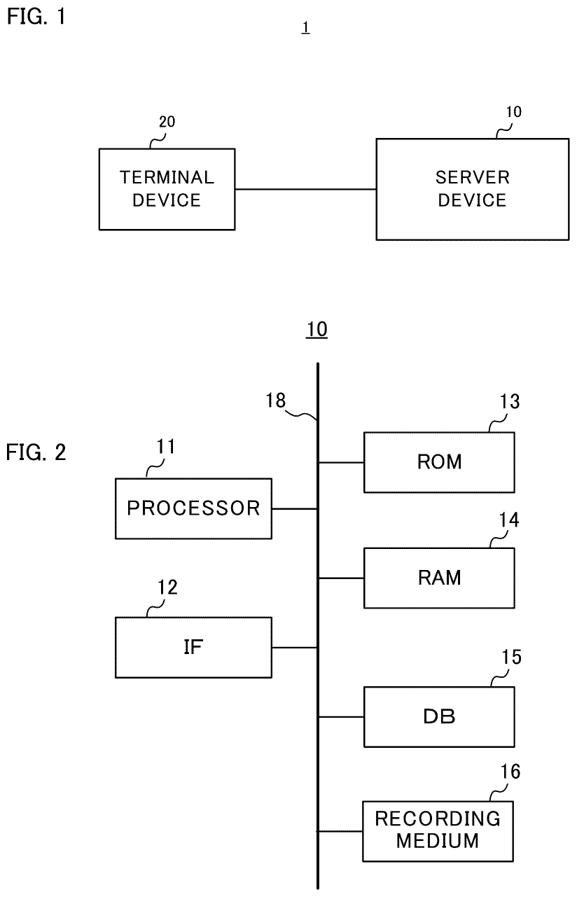

FIG. 1 illustrates an overall configuration of a design support system (hereinafter, simply referred to as a “design support system”) of a machine learning model to which an information processing device according to the present disclosure is applied. The design support system 1 receives designation of a task from the designer of the machine learning model (hereinafter referred to as a “user”), and generates one or more input variables used by the machine learning model to execute the designated task. As illustrated, the design support system 1 includes a server device 10, and a terminal device 20. The server device 10 and the terminal device 20 can communicate via a wired or wireless network.

The terminal device 20 is operated by the user who designs and manages the machine learning model. The user specifies the task of interest to the terminal device 20. Although details will be described later, the terminal device 20 includes a natural language model capable of interpreting a natural language. The user inputs a prompt written in the natural language including the specification of the task, to the terminal device 20. Note that the “prompt” refers to an instruction sentence to a generative Al (Artificial Intelligence) including a natural language model or the like. The terminal device 20 receives the input of the prompt including a designation of the task, and recognizes the task designated by the user by interpreting the prompt using the natural language model.

The server device 10 stores prediction-related information prepared in association with various tasks in a database or the like. The terminal device 20 accesses the database of the server device 10 and acquires the prediction-related information concerning the task designated by the user. The terminal device 20 acquires one or more input variables to be used in the machine learning model for performing the designated task using the acquired prediction-related information. Here, each “input variable” refers to a concept indicating an explanatory variable or feature used by the machine learning model to acquire a result corresponding to the designated task. For instance, in a case where the designated task is to predict a product demand using regression, the objective variable represents the product demand, and each explanatory variable in a predictive formula for acquiring the objective variable corresponds to the input variables. Also, in a case where the designated task is classification using a classification model, each feature input to the classification model is the input variable.

The tasks designated by the user include, for instance, various tasks such as prediction tasks of predicting the product demand, predicting an electric power demand, a classification task of classifying input information, and the like. Note that in the following description, the task designated by the user is assumed to predict the product demand in a certain store.

The terminal device 20 acquires each input variable suitable for predicting the product demand which is the designated task using the prediction-related information. Specifically, the server device 10 selects the input variable suitable for predicting the product demand from a large number of input variables included in the prediction-related information. Moreover, the server device 10 can also generate a new input variable which is not included in the prediction-related information, if necessary. The terminal device 20 outputs the acquired input variable as an answer to the prompt input by the user. In this way, it is possible for the user to acquire each input variable suitable for the machine learning model in order to execute the designated task by performing input in the natural language to the server device 10.

### [Natural Language Model]

In the following, the natural language model will be described. The natural language model is a model which learns a relationship between words in a sentence, and generates a relevant string concerning a target string from the target string. By using the natural language model which learns sentences and texts of various contexts, it is possible to generate the relevant string with appropriate content concerning the target string. For instance, a case where the natural language model is used in a question and answer will be described. In this case, the natural language model accepts an input of a question “What kind of country is Japan?” as the target string, and generates “Japan is an island country in the northern hemisphere . . . ” as the answer to the question.

A learning method of the natural language model is not particularly limited, but may be a model which is trained to output at least one sentence including an input string as an example. For instance, the natural language model may be a GPT (Generative Pre-Training) which outputs a sentence containing the input string by predicting a string with a high probability of following the input string. Alternatively, the natural language model such as T5 (Text-to-Text Transfer Transformer), BERT (Bidirectional Encoder Representations from Transformers), RoBERTa (Robustly optimized BERT approach), and ELECTRA (Efficiently Learning an Encoder that Classifies Token Replacements Accurately) can be used. In the present example embodiment, a large-scale language model may be used as the natural language model. Also, the natural language model may be capable of accessing the Internet or other specialized knowledge bases to obtain information.

### [Hardware Configuration]

### (Server Unit)

FIG. 2 is a block diagram illustrating a hardware configuration of the server device 10. As illustrated in FIG. 2, the server device 10 includes a processor 11, an interface (IF) 12, a ROM (Read Only Memory) 13, a RAM (Random Access Memory) 14, a database (DB) 15, and a recording medium 16. These components are mutually connected, for instance, through a bus 18.

The processor 11 is a computer such as a CPU (Central Processing Unit), and controls the entire server device 10 by executing a program prepared in advance. Specifically, the processor 11 may be a CPU, a GPU (Graphics Processing Unit), a DSP (Digital Signal Processor), a MPU (Micro Processing Unit), an FPU (Floating Point number Processing Unit), a PPU (Physics Processing Unit), a TPU (Tensor Processing Unit), a quantum processor, a microcontroller, or a combination thereof.

Also, the processor 11 loads the program stored in the ROM 13 or the recording medium 16 to the RAM 14, and executes the processes coded in the program. The processor 11 acts as part or all of the server device 10.

The IF 12 transmits and receives data to and from an external device. Specifically, the server device 10 transmits and receives data to and from the terminal device 20 through the IF 12.

The ROM 13 stores various programs executed by the processor 11. The RAM 14 is used as a working memory during various processes performed by the processor 11. The DB 15 stores the prediction-related information for various tasks. The prediction-related information will be described later.

The recording medium 16 is a non-volatile and non-transitory recording medium such as a disc-shaped recording medium or a semiconductor memory. The recording medium 16 may be detachably formed to the server device 10. The recording medium 16 records various programs executed by the processor 11.

### (Terminal Device)

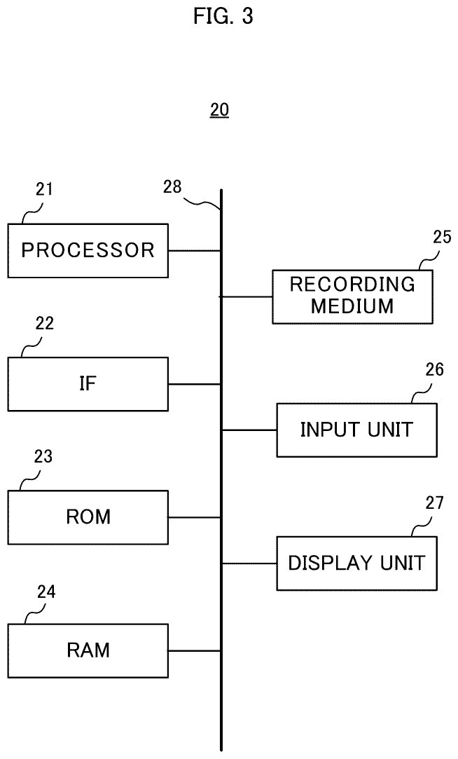

FIG. 3 is a block diagram illustrating a hardware configuration of the terminal device 20. The terminal device 20 is, for instance, a PC or a tablet terminal. As illustrated in FIG. 3, the terminal device 20 includes a processor 21, an IF 22, a ROM 23, a RAM 24, an input unit 26, and a display unit 27. These components are mutually connected, for instance, through a bus 28.

The processor 21 is a computer, such as a CPU, and controls the entire terminal device 20 by executing programs prepared in advance. The processor 21 may be a GPU, FPGA, DSP, ASIC or the like.

The IF 22 transmits and receives data to and from an external device. Specifically, the terminal device 20 accesses the DB 15 of the server device 10 through the IF 22 and acquires the prediction related information.

The ROM 23 stores various programs executed by the processor 21. Also, the RAM 24 is used as a working memory during various operations performed by the processor 21.

A recording medium 25 is a non-volatile and non-transitory recording medium such as a disc-shaped recording medium or a semiconductor memory. The recording medium 25 may be detachably formed to the terminal device 20. The recording medium 25 records various programs executed by the processor 21.

The input unit 26 is, for instance, an input device such as a keyboard, a mouse, or a touch panel. The user inputs a prompt including designating a task by operating the input unit 26. The display unit 27 is a display or the like for displaying based on a control of the processor 21. An answer which the user input to the prompt is displayed on the display unit 27 and presented to the user.

### [Function Configuration]

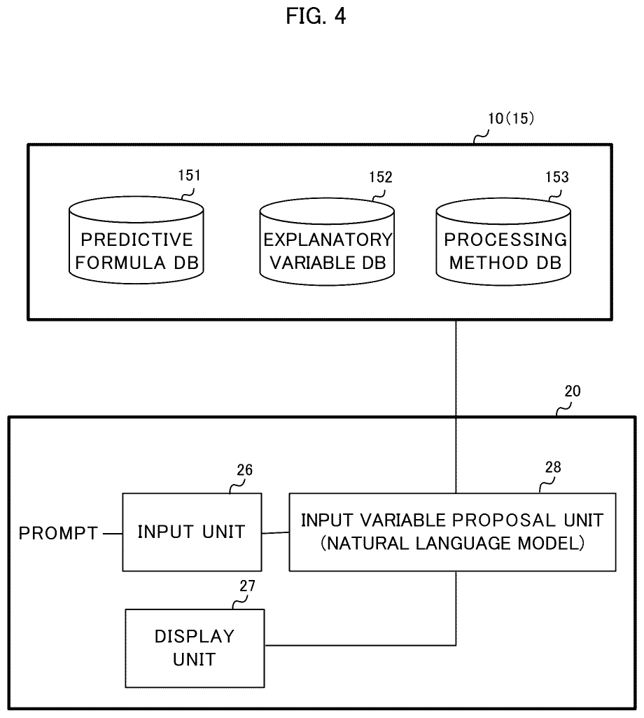

FIG. 4 is a block diagram illustrating functional configurations of the server device 10 and the terminal device 20. The server device 10 includes a predictive formula DB 151, an explanatory variable DB 152, and a processing method DB 153 in the database 15. On the other hand, the terminal device 20 includes an input variable proposal unit 28 in addition to the input unit 26 and the display unit 27 described above.

As described above, the database 15 stores the prediction-related information. The prediction-related information includes a predictive formula, explanatory variables, and a processing method. The predictive formula DB 151 stores the predictive formula, the explanatory variable DB 152 stores the explanatory variable, and the processing method DB 153 stores the processing method.

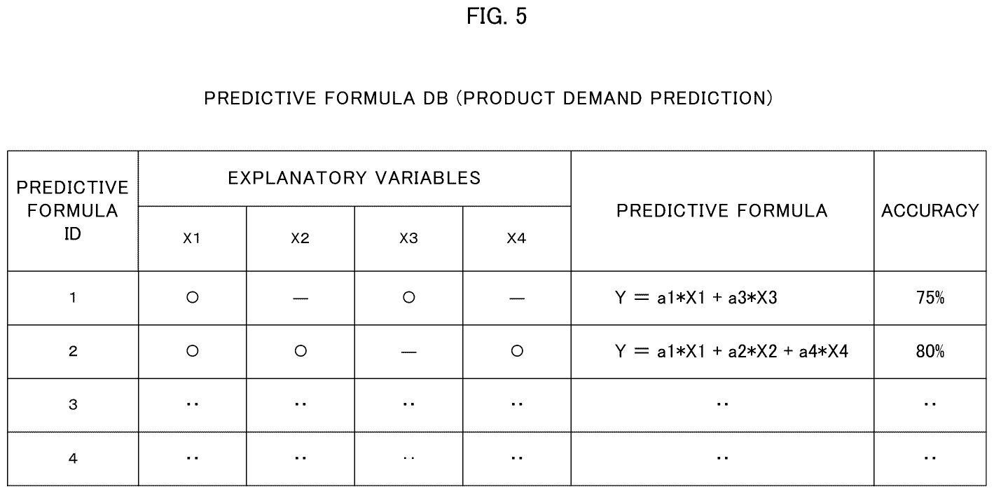

FIG. 5 illustrates an example of the predictive formula DB 151 storing the predictive formula data. The predictive formula DB 151 stores the predictive formulae representing respective tasks. In the example in FIG. 5, the predictive formula DB 151 stores the predictive formula data which are used for the task “product demand prediction”. Specifically, the predictive formula data include items of “predictive formula ID”, “explanatory variables”, “predictive formula”, and “accuracy”. The item “predictive formula ID” corresponds to identification information of each predictive formula. The item “explanatory variables” represent one or more variables used in each predictive formula. The item “predictive formula” represents a mathematical formula for each predictive formula. The item “accuracy” indicates the accuracy of the prediction by each predictive formula.

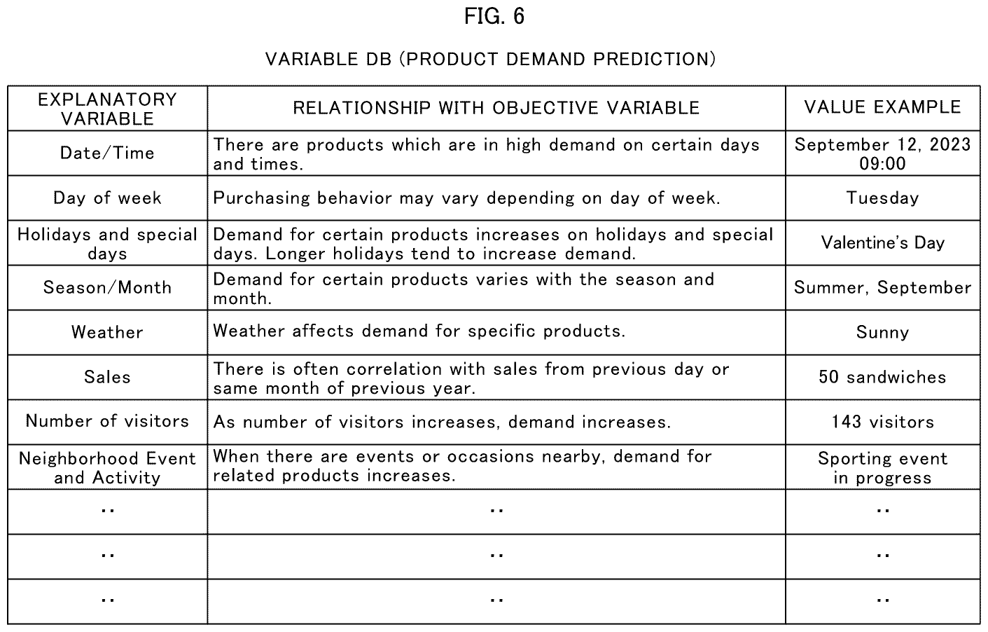

FIG. 6 illustrates an exemplary of the explanatory variable DB 152 storing explanatory variable data. The explanatory variable DB 152 stores, for each task, the explanatory variable data representing each explanatory variable used for the prediction corresponding to the task. In the FIG. 6, the explanatory variable DB 152 stores the explanatory variable data for each explanatory variable used for the task “product demand prediction”. Specifically, the explanatory variable data include items of “explanatory variable”, “relationship with the objective variable”, and “value example”. The item “relationship with the objective variable” is represented by information which indicates a relationship between each explanatory variable and the objective variable of the task (in this example, the product demand). The item “value example” indicates an example represented as a numerical value which each explanatory variable can take.

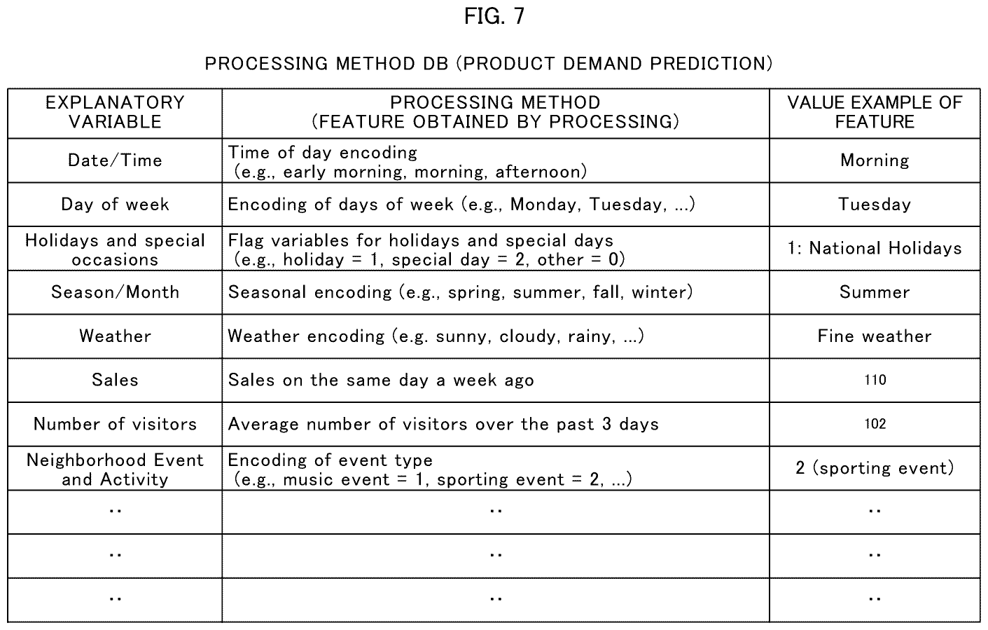

FIG. 7 illustrates an example of the processing method DB 153 storing processing method data. The processing method DB 153 stores the processing method data indicating the processing method of the explanatory variables used for the prediction corresponding to a task for each task. In the predictive formulas, a variable obtained by processing each explanatory variable in accordance with a predetermined method may be used. For instance, for the explanatory variable “Sales”, variables may be defined from different perspectives and used for the prediction, such as “Sales per day” and “Average sales over the last 7 days” depending on that period. As described above, the variable processed for use in the prediction are referred to as a “processing variable” or a “feature”. The processing method DB 153 illustrates processing methods respectively corresponding to explanatory variables. That is, the processing method data illustrates how each explanatory variable is processed and used for a predictive model. As the processing methods for the explanatory variables, there are a method for defining four arithmetic operations among a plurality of explanatory variables, a method for calculating a predetermined statistical value such as a moving average, and the like.

In the example in FIG. 7, the processing method DB 153 stores the processing method data of the plurality of explanatory variables used for the task “product demand prediction”. Specifically, the processing method data include the explanatory variables, the processing method, and the value example of the feature. The processing method illustrates how each explanatory variable is processed and used. The value example of feature indicates an example of a value which is obtained by processing the explanatory variable and may be represented by a numerical value.

Referring back to FIG. 4, in the terminal device 20, the input unit 26 receives the prompt input by the user and outputs the prompt to the input variable proposal unit 28. The input variable proposal unit 28 interprets the input prompt using the natural language model and recognizes the designation of the task by the user. Moreover, by interpreting the prompt, the input variable proposal unit 28 recognizes additional information other than the designation of the task, for instance, a condition under which the input variable is to be obtained. Next, the input variable proposal unit 28 accesses the database 15 of the server device 10 to refer to each of the DB 151 to DB 153, and acquires each input variable suitable for the prediction model corresponding to the designated task. The input variable proposal unit 28 displays the acquired input variable on the display unit 27. By these processes, it is possible for the user to obtain the answer to the prompt which has been input. That is, by inputting a prompt designating a task in natural language, the user can know each input variable suitable for the model executing the task.

Specifically, the input variable proposal unit 28 refers to the predictive formula DB 151, selects one or more predictive formulae used for the designated task, and acquires one or more explanatory variables respectively used by the predictive formulae as the input variables. Moreover, the input variable proposal unit 28 may refer to the explanatory variable DB 152 and acquire value examples of the relationships between each explanatory variables and the task, and present each value example acquired, to the user. In addition, in a case where the acquired predictive formula includes a feature obtained by processing the explanatory variable, the input variable proposal unit 28 may refer to the processing method DB 153 and present an explanation (processing method) of that feature, a value example of that feature, and the like to the user. By these processes, it is possible for the user to know a reason or rationale for each input variable being proposed.

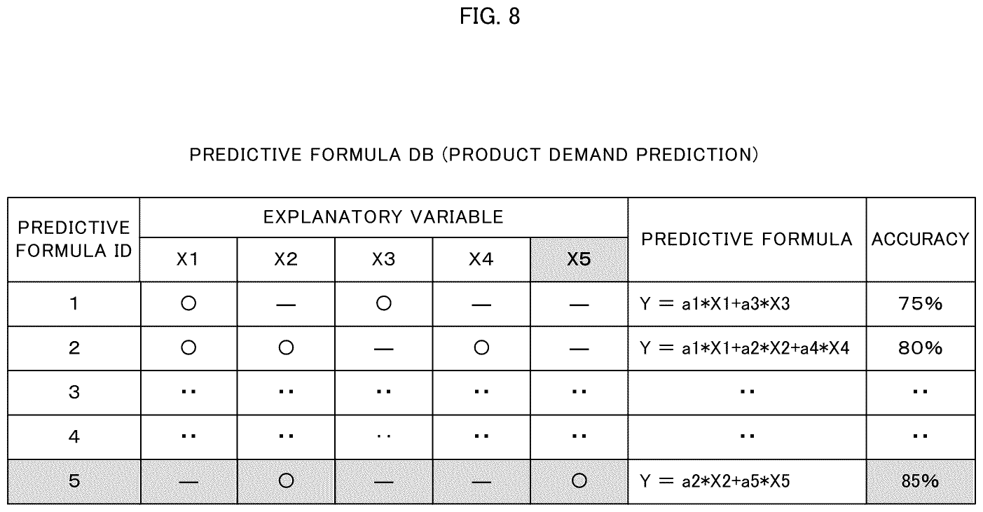

The input variable proposal unit 28 may generate a new predictive formula that is not included in existing predictive formula data. For instance, as illustrated in FIG. 8, the input variable proposal unit 28 may generate a new explanatory variable X5 using existing explanatory variables X1 to X4, and generate a new predictive formula 5 using the explanatory variable X5. In this instance, the explanatory variable X5 may be calculated by the four arithmetic operations using two or more of the explanatory variables X1 to X4, for instance.

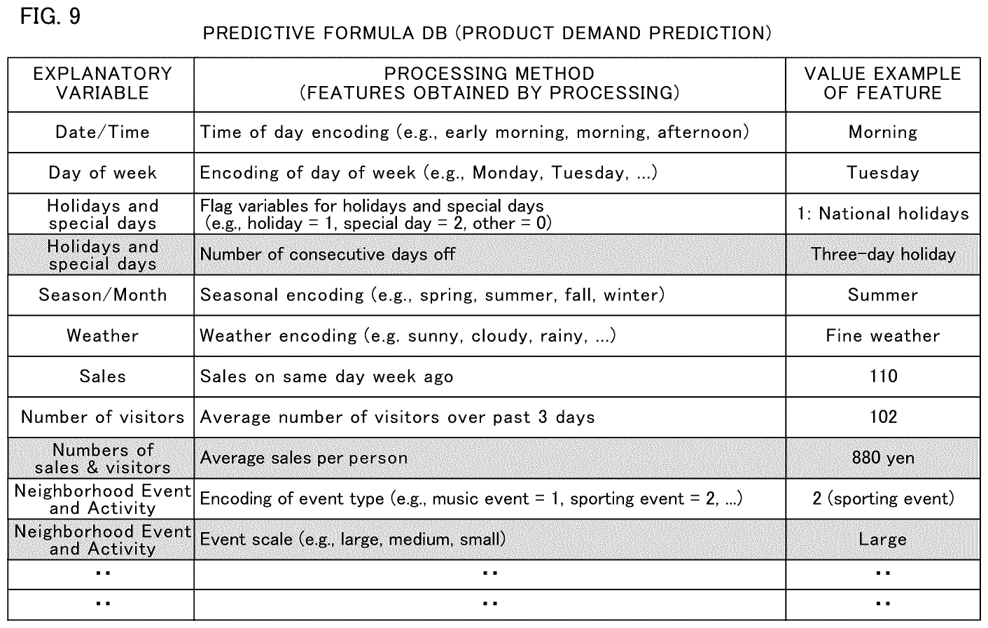

The input variable proposal unit 28 may generate a new processing method that is not included in the existing processing method data. For instance, as illustrated in FIG. 9, the input variable proposal unit 28 may generate a feature “Number of consecutive holidays” based on the explanatory variable “Holidays and special days”. In addition, the input variable proposal unit 28 may generate a feature of “Average sales per person” based on the explanatory variables “sales” and “number of customers”. The input variable proposal unit 28 may generate a feature of “Event scale” based on an explanatory variable of “Neighborhood event and activity”.

Accordingly, by generating the new predictive formula, explanatory variables, and features based on the existing predictive formula, explanatory variables, features, and the like, it becomes possible to propose more appropriate input variables in various situations. Moreover, a new predictive formula, feature, and the like generated by the input variable proposal unit 28 in a plurality of terminal devices 20 are registered in the DB 15 of the server device 10, so that the latest prediction-related information can be shared among users of the plurality of terminal devices 20.

### Operation Example

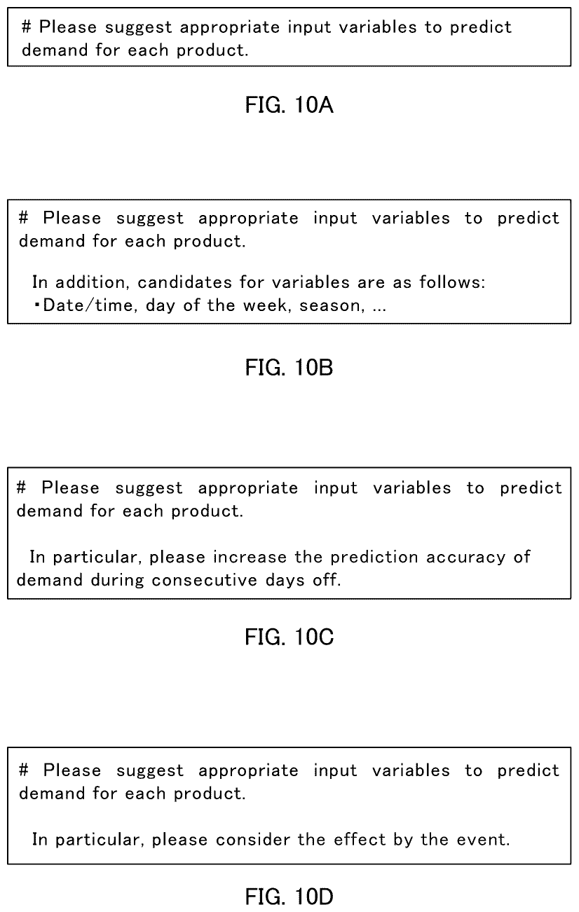

Next, an operation example of the support system 1 will be described. FIG. 10A, FIG. 10B, FIG. 10C, and FIG. 10D illustrate examples of prompts input by the user.

Basically, the user can receive a proposal for one or more input variables appropriate to the task by designating at least the task at the prompt which is input. In the example in FIG. 10A, the user designates the task “product demand prediction” and requests the proposal of the input variables. In this case, the input variable proposal unit 28 can output an appropriate number of predictive formulae, the input variables used for the predictive formulae, relevance to the objective variable of each input variable, and the like. In a case of presenting the plurality of predictive formula, the input variable proposal unit 28 may sort them with accuracy or the like and output the predictive formula. In addition, in a case of proposing the plurality of input variables, the input variable proposal unit 28 may sort and output the plurality of input variables in accordance with the relationship to the objective variable, a degree of correlation with the objective variable, and an actual ease of availability of data of each of the plurality of input variables.

The user can describe the additional information such as a condition concerning a proposal of one or more input variables at a prompt to be input. For instance, as illustrated in the example in FIG. 10B, the user may present candidates for input variables. In this case, the input variable proposal unit 28 may output whether each candidate for the one or more input variables presented by the user is appropriate together with that reason, that rationale, and the like. Moreover, the input variable proposal unit 28 may propose an alternative input variable which is more appropriate than the candidate presented by the user.

Also, the user may request to present one or more input variables which are actually being used, rather than each candidate for the input variables, and to propose the one or more input variables to be used additionally.

The user may indicate that a certain matter is to be considered as a condition regarding the proposal of the input variables. For instance, in the example in FIG. 10C, the user sets a condition of “increasing the prediction accuracy of demand during consecutive holidays” regarding the task of the product demand prediction. In this case, the input variable proposal unit 28 may make a proposal that refers to the prediction-related information, and emphasizes especially the explanatory variable or the feature concerning the holiday. For instance, as illustrated in FIG. 7, in the processing method DB 153, it is assumed that the prompt in FIG. 10C is input in a state in which the feature of “Number of consecutive days off” does not exist for the explanatory variable of “Holidays and special days”. In this case, the input variable proposal unit 28 may generate a new feature of “Number of consecutive holidays” for the explanatory variable “Holidays and special days” as illustrated in FIG. 9 based on the prompt in FIG. 10C, and may propose the new feature as the input variable.

Moreover, in the example in FIG. 10D, the user sets a condition of “considering the effect by the event” concerning the task of the product demand prediction. In this case, the input variable proposal unit 28 may create a proposal which refers to the prediction-related information, and emphasizes especially the explanatory variable or the feature related concerning the event. For instance, as illustrated in FIG. 7, it is assumed that a prompt in FIG. 10D is input in a state in which the feature of “Event scale” does not exist for the explanatory variable “Neighborhood event and activity” in the processing method DB 153. In this case, the input variable proposal unit 28 may generate a new feature of “Event scale” for the explanatory variable of “Neighborhood Event and Activity” as illustrated in FIG. 9 based on the prompt in FIG. 10D, and propose the new feature as the input variable.

### [Input Variable Proposal Process]

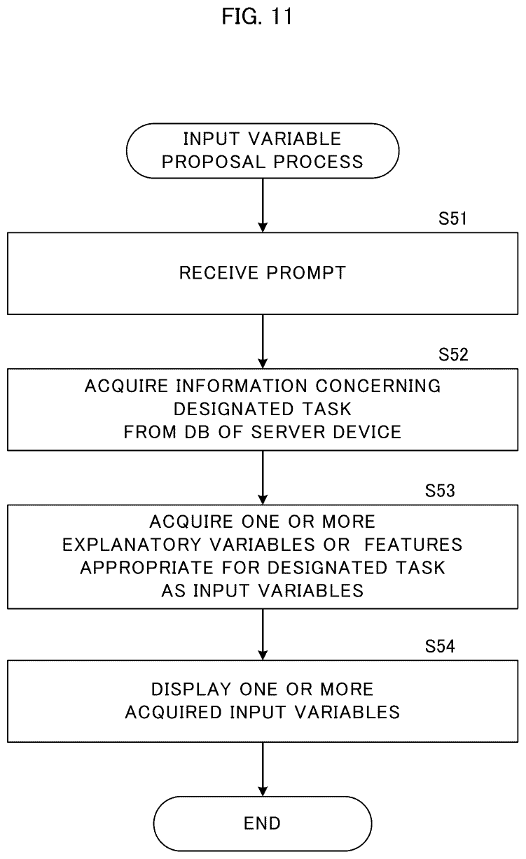

Next, a flow of an input variable proposal process will be described. FIG. 11 is a flowchart of the input variable proposal process. This input variable proposal process is realized by the processor 21 illustrated in FIG. 3 which executes a corresponding program prepared in advance and operates as an element illustrated in FIG. 4.

First, the terminal device 20 receives the prompt generated by the user (step S51). Next, the terminal device 20 interprets the prompts using the natural language model and acquires the prediction-related information concerning the designated task from the DB 15 of the server device 10 (step S52). Next, if a condition is included in the prompt, the terminal device 20 considers that condition, and obtains one or more explanatory variables or features suitable for the designated task as the input variables (step S53). At this time, if necessary, the terminal device 20 generates a new predictive formula, one or more explanatory variables, one or more feature, or the like. Then, the terminal device 20 displays each input variable on the display unit 27 (step S54). Accordingly, the input variable proposal process is terminated.

### [Modifications]

Next, modifications of the above example embodiment will be described. The following modifications can be combined as appropriate.

### (Modification 1)

In the example embodiment described above, the input variable proposal unit 28 including the natural language model is provided in the terminal device 20. Alternatively, one input variable proposal unit may be provided in the server device 10, and the input variable proposal unit may propose one or more input variables. In this case, the terminal device 20 transmits a prompt input by the user to the server device 10. In the server device 10, the input variable proposing unit accesses the DB 15 to refer to the prediction-related information, acquires one or more input variables suitable for the task designated by the user, and transmits a result to the terminal device 20.

### (Modification 2)

The predictive DB 151, the explanatory variable DB 152, and the processing method DB 153 which are stored in the DB 15 of the server device 10 may store data described in natural language. In this case, the input variable proposal unit proposes one or more appropriate input variables using the prompt written by the user in natural language and the prediction-related information written in natural language.

### Second Example Embodiment

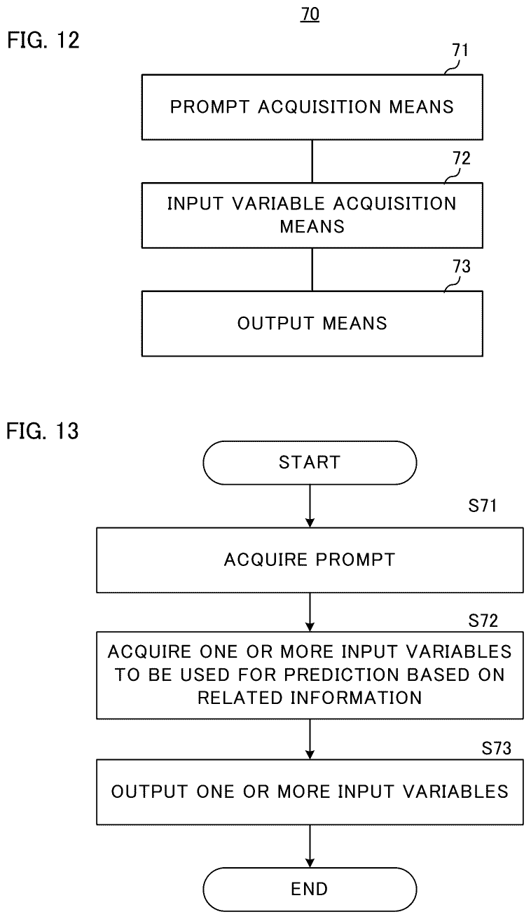

FIG. 12 is a block diagram illustrating a functional configuration of an information processing device according to a second example embodiment. An information processing device 70 includes a prompt acquisition means 71, an input variable acquisition means 72, and an output means 73.

FIG. 13 is a flowchart of a process performed by the information processing device according to the second example embodiment. The prompt acquisition means 71 is described in natural language and acquires a prompt including a designation of a task (step S71). The input variable acquisition means 72 interprets the prompt using a language model, acquires related information corresponding to the task designated by the prompt, and acquires one or more input variables for prediction corresponding to the designated task based on the related information (step S72). The output means 73 outputs the one or more input variables which have been acquired (step S73).

According to the information processing device 70 of the second example embodiment, it is possible even for a person who does not necessarily have sufficient knowledge and experience regarding the development or operation of the machine learning model to acquire one or more appropriate explanatory variables or features related to a target task.

A part or all of the example embodiments described above may also be described as the following supplementary notes, but not limited thereto.

### (Supplementary Note 1)

1. An information processing device comprising:
a prompt acquisition means configured to acquire a prompt which is described in natural language and includes a designation of a task;
an input variable acquisition means configured to interpret the prompt using a language model, acquire related information corresponding to the task designated by the prompt, and acquire an input variable to be used for prediction corresponding to the task designated, based on the related information; and
an output means configured to output the input variable acquired.

### (Supplementary Note 2)

2. The information processing device according to supplementary note 1, wherein the input variable acquisition means generates a new input variable not included in the related information.

### (Supplementary Note 3)

3. The information processing device according to supplementary note 1, wherein
the related information is described in natural language, and
the related information includes a predictive formula corresponding to the task designated, the input variable to be used for the prediction corresponding to the task designated, and a processing method of the input variable.

### (Supplementary Note 4)

4. The information processing device according to supplementary note 3, wherein the input variable acquisition means generates a new input variable from among a plurality of existing input variables included in the related information, based on the prompt and the related information.

### (Supplementary Note 5)

5. The information processing device according to supplementary note 4, wherein the input variable acquisition means generates a new predictive formula which uses the new input variable.

### (Supplementary Note 6)

6. The information processing device according to supplementary note 3, wherein the input variable acquisition means generates a new processing method of the input variable and a new input variable which is acquired by the processing method, based on the prompt and the related information.

### (Supplementary Note 7)

7. The information processing device according to supplementary note 6, wherein
the related information is stored in a storage unit,
the input variable acquisition means acquires the related information from the storage unit, and
the input variable acquisition means stores the new processing method and the new input variable which are generated, in the storage unit.

### (Supplementary Note 8)

8. The information processing device according to supplementary note 1, wherein
the prompt includes a condition concerning the task, and
the input variable acquisition means acquires the input variable satisfying the condition.

### (Supplementary Note 9)

9. An information processing method performed by a computer and comprising:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

### (Supplementary Note 10)

10. A program causing a computer to execute processing of:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

This application is based upon and claims the benefit of priority from Japanese Patent Application 2023-209025, filed on Dec. 12, 2023, the disclosure of which is incorporated herein in its entirety by reference.

### DESCRIPTION OF SYMBOLS

10 Server device
20 Terminal device
21 Processor
26 Input unit
27 Display unit
28 Input variable proposal unit
15 Database (DB)
151 Predictive formula DB
152 Explanatory variable DB
153 Processing method DB

1. An information processing device comprising:
at least one memory configured to store instructions; and
at least one processor configured to execute the instructions to:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

2. The information processing device according to claim 1, wherein the processor generates a new input variable not included in the related information.

3. The information processing device according to claim 1, wherein
the related information is described in natural language, and
the related information includes a predictive formula corresponding to the task designated, the input variable to be used for the prediction corresponding to the task designated, and a processing method of the input variable.

4. The information processing device according to claim 3, wherein the processor generates a new input variable from among a plurality of existing input variables included in the related information, based on the prompt and the related information.

5. The information processing device according to claim 4, wherein the processor generates a new predictive formula which uses the new input variable.

6. The information processing device according to claim 3, wherein the processor generates a new processing method of the input variable and a new input variable which is acquired by the processing method, based on the prompt and the related information.

7. The information processing device according to claim 6, wherein
the related information is stored in a storage unit,
the processor acquires the related information from the storage unit, and
the processor stores the new processing method and the new input variable which are generated, in the storage unit.

8. The information processing device according to claim 1, wherein
the prompt includes a condition concerning the task, and
the processor acquires the input variable satisfying the condition.

9. An information processing method performed by a computer and comprising:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.

10. A non-transitory computer-readable recording medium storing a program, the program causing a computer to execute processing of:
acquiring a prompt which is described in natural language and includes a designation of a task;
interpreting the prompt using a language model, acquiring related information corresponding to the task designated by the prompt, and acquiring an input variable to be used for prediction corresponding to the task designated, based on the related information; and
outputting the input variable acquired.
